(19) United States
(12) Patent Application Publication
(10) Pub. No.: US 2006/0116941 A1
(43) Pub. Date: Jun. 1, 2006

(54) Investment vehicle for guaranteed lump sum payout and rollover/income option

(76) Inventor: Charles Joseph Lombardo, Dublin, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/000,646

(22) Filed: Dec. 1, 2004

(51) Int. Cl. G06Q 40/00

(52) U.S. Cl. 705/35; 705/40

(57) ABSTRACT

An investment vehicle that returns a stated payout to an investor where an entity invests an amount necessary to return the payout based on expected known outcomes to achieve market compounded rates of return is described.

### FIELD OF THE INVENTION

The present invention relates to insurance methods and systems and more particularly to a system and method to provide a person with a guaranteed future amount based an initial contribution and a determined term of investment.

### BACKGROUND OF THE INVENTION

Over the last twenty-five years, retirement plans have gravitated from employers sponsoring defined benefit plans, such as monthly retirement checks, to defined contribution plans, such as 401(k)'s. With this transition, investment management has migrated from the trustee of the defined benefit plan who typically served as a trained money manager at a bank or financial institution, to individual consumers, who are generally not as sophisticated at investing or at determining what level of contributions are necessary to achieve a desired level of retirement dollars.

Stocks perform better when the rate of inflation is stable or slowing. Faster inflation lowers the value of future cash flows paid by stocks because those future dollars will buy fewer goods and services than they do today. Because inflation fell in period from the 1980's through the 1990's, stock mutual funds gained significant growth. The Dow, a measure of the U.S. stock market calculated by the Dow Jones Corporation, rose over 300% between 1982 and 1996 (adjusted for inflation; MacEwan, A.; U.S. Stock Market vs. the Economy, Dollars and Sense Magazine, Sept/Oct 1997). During this period, individuals felt that the returns that they realized related to their knowledge of financial risk; thus, individual consumers felt confident to invest on their own and enjoyed the trends of this period.

The market growth of the 1990's came to an end with the years 2000, 2001, and 2002 producing the longest and deepest downturn in equities since the Great Depression. Suffering losses in the turndown, many individuals realized that they lacked knowledge and understanding of investing, particularly for saving for retirement.

The U.S. stock market has been volatile in recent years. The current market is one of fluctuation—typically showing an improvement for a given period and then turning down over another period—making it difficult for uninformed investors to develop an investment model that would allow them to reach their financial goals.

Over any given short term period, the market deviates widely. One measurement of movement in the market is the Standard & Poor's 500 Index (S&P Index), which was created in 1957. The S&P Index is weighted by the market value of 500 U.S. publicly traded companies and is thought to be representative of the stock market as a whole (prior to 1957, the S&P Index contained 90 blue-chip stocks). The S&P Index has been down as much as 50% in a given year from the reported S&P Index of the prior year, and up more than 60% in others.

While the market is generally volatile over a short period, such as from year to year, over longer periods the overall market trend is generally upward. A review of the S&P Indices over the past 80 years shows that the movements flatten out when averaged over this period of time. Annualized returns of the S&P Index for individual forty year periods beginning in each of the years 1926-1965 are approximately 9% to approximately 11% (calculated as the next year ending value minus the prior year value divided by the prior year value). The averaged rate of return of the 40 year periods from 1926-1965 through 1965-2004 is 10.8%.

An individual consumer taking advantage of an investment in the market over a similar period of time should be able to enjoy a similar rate of return to enable the individual to reach his/her financial goals, such as retirement. Unfortunately, human nature tends to make some individuals react to situations incorrectly so that they miss such opportunities. Problems with long-term investment strategies include:
1. Excessive risk, such as chasing rates of returns higher than 10%, only to be caught up in a downturn. Investment in technology stocks of the late 1990's is an example of excessive risk.
2. Timing, such as moving out of equity positions at the wrong time. For example, the 2000-2002 market was down 40%, causing individuals get out for fear of more losses. In 2003, the market moved up 34%. The individuals that sold in the down market missed the gain years that would have tempered the losses of the downturn years.
3. Uncertainty. The uncertainty about what the future will hold no matter how much money an individual saves forces some individuals into buying risky investments. These investments rarely improve a retirement program.

One method that individuals typically use in an attempt to overcome their uncertainty about their investments is to invest in a fund, where the money they contribute is invested by institutional investors, such as public and corporate funds, banks, insurance companies, and the like. Institutional investment companies benefit from numerous professional resources that allow them to overcome the biases of individuals. Because institutional investment companies are large investors in the market, they usually employ professional investment managers that make investment decisions on behalf of the company. The company's funds are typically invested in an index, so its yield is the index mean. While there may be fluctuations in the market, the fund as a whole absorbs those fluctuations overtime, and no individual is subject to the variations.

Insurance companies typically offer a variety of investment vehicles, such as annuities and the like. Annuities are investment vehicles that provide periodic payments over a period of time, such as the life of an individual and provide a steady flow of income. The payments may be contingent upon the individual being alive or may be non-life-contingent. The payments are paid out (the “payout period”) generally over a fixed term of years or for so long as an individual lives. Payments may be deferred to start on a set future date, or may commence immediately upon purchase of the product. When an individual that has purchased an annuity dies, a beneficiary may receive the remaining assets of the product.

Insurance companies invest the premiums from annuities as well as those received from traditional insurance contracts to ensure the ability to pay when claims occurs. Insurance companies employ strategies to ensure that funds necessary to satisfy claims occurring on expected dates are available. Strategies include investment in corporate equity securities, bonds, real estate ventures, the market and the like. Insurance companies also purchase debt, such as long term corporate and government bonds and mortgage loans, that matures on a date coinciding with the date that funds to cover claims are required. The purchase of loans includes determining basis points. Basis points (bps) are the premium paid over the base rate of a lending agreement (a basis point is one hundredth of a percentage point; i.e., 100 basis points is 1%).

Reinsurance is the practice of purchasing insurance to cover all or part of certain risks. The reinsurer agrees to provide coverage for all or part of losses that an entity may incur under certain risks. Reinsurance typically protects an entity from a loss in excess of a predetermined amount. In a reinsurance transaction, the reinsurer agrees to indemnify an entity for a portion of the loss or losses that may arise, such as under an insurance contract, in exchange for a portion of the premium.

Reinsurance is generally used to provide catastrophe protection and to provide for stable results from period to period. An entity may purchase reinsurance to provide stability for year-to-year potential losses. If an entity, such as an insurance company expects a substantial number of claims to be filed at a future date, it employs a reinsurance strategy to plan for the increase in liability and stabilize reporting data. If the losses are less than the predetermined amount, the entity incurs only the cost of the reinsurance.

Reinsurance may be in-house or transacted among several entities. To redistribute risk, a reinsurer may cede risk to another reinsurer. Reinsurance may be on an instrument by instrument basis, or an entity may cede all or part of its entire book of business under the terms of a reinsurance contract.

Long term investments generally pay higher interest rates. A $100 investment in 1926 in a fund paying the S&P Index each year would have yielded $188,000 at the end of 2003. Lower risk, non-government 40-year term bonds currently pay about 7%. Over the years, the interest rate on such instruments has been higher—as much as 10% in early 1980's—but has generally been around the 7-8% range.

Investment income from premiums invested by insurance companies depends on the basic asset allocation and the specific types of investments. Most insurance companies diversify investments between low and high risks. Higher risk investments generally yield more than the 7-8% of these lower risk bonds. “Beta” is a measurement of an investment relative to the market over an extended period. If the investment return moves up and down exactly in line with the market, the investment's beta is 1.0. A beta of more than one means that the investment is more volatile than the market as a whole. An investment's beta may be measured over different time periods.

An investment with a beta of “2” is two times as volatile as the overall market. Where the market is expected to provide a return of 10%, an investment with a beta of 2 would return 20%. Likewise, a 2-beta investment would return −20% when the market provides a −10% return.

An individual saving for retirement invests for use in the future, typically 35 to 40 years from the first date of investment. Many low-risk investments do not provide sufficient revenue for an individual to achieve retirement, so the individual invests in higher risk, higher interest investments. However, higher risk investments typically offer no guarantee of the eventual payout. Therefore, an individual typically has no guarantee of a given amount of funds upon a desired retirement date.

A need exists for an investment vehicle that:
1. Eliminates the risk of the market from individual investors, so that they do not create mistakes that can ruin their retirement goals;
2. Places the individual's money with an entity that can weather the downturns because it understands that downturns will reverse and expected rates of return will be achieved;
3. Guarantees the results, so that the investor knows exactly what to expect when he/she reaches retirement; and
4. Provides higher guaranteed returns than current payout/income products do at this time.

### SUMMARY OF THE INVENTION

The present invention provides an investment vehicle that will return, with 100% certainty to the investor or holder (also individual and or customer), a stated rate of return. By using the investment parameters of the present invention, an entity that writes a contract for the individual's investment will be able to guarantee the stated return, as well as create a large pool of gross margin for the entity.

Using the system of the present invention, each individual can plan for his/her retirement at a date certain without concern for market risk. The entity that writes the contract for the investment will have the “expected known outcomes” to withstand the downturn years of the market and put into perspective the growth years, so that the necessary market compounded rate of return can be achieved.

The present invention comprises an investment vehicle comprising a term, a guaranteed payout goal with the option of a rollover to create a future stream of payouts, one or more periodic payment made by an individual purchasing the investment, a loan from a loaner to the entity, and an investment tool. The loan bears interest equal to the present value of the payout goal. In an embodiment, interest rates range from about 6% to about 9%. The term equals a sufficient number of years to mitigate downswings in the market, based on historical data. In an embodiment, terms of products range from about 10 to about 40 years.

Periodic payments are made by the individual to the entity on a predetermined basis, such as bi-weekly, weekly, every other week, bi-monthly, monthly, every other month, quarterly, bi-yearly, or yearly. The individual may add a lump-sum amount to the purchase of the product. The amount of the periodic payments is determined by the entity based on the payout goal, the term and any optional lump-sum contributed by the individual. An employer of the individual optionally contributes an amount to the payments. In an embodiment, the entity transfers the periodic payments paid by the individual to the loaner during the term.

The entity invests the loan in a tool over the term. The tool includes but is not limited to at least one 2-beta investment based on the S&P Index compounded rate throughout the term. The tool is optionally a combination of a 2-beta investment and a lower risk investment, an investment with a beta of less than 2, and the like. In an embodiment, the tool is a combination of a 2-beta investment and a lower risk investment. The percentages of the loan that the entity invests in the 2-beta investment versus the lower risk investment can be any amount. In an embodiment, the percentage of the loan invested in a 2-beta investment ranges from about 25% to about 1%, and the lower risk percentage is about 99% to about 75%. In a preferred embodiment, the 2-beta investment percentage is about 5% to about 10% of the loan and the lower risk investment is about 90% to about 95%.

The entity optionally reinsures the product. The entity can purchase reinsurance for each product or all or part of its book of business. Purchasing reinsurance ensures a guaranteed rate of return for the entity.

The individual receives the payout at the end of the term. The product may be for any term and interest rate to equal a desired payout. In an embodiment, the product has a term of 40 years, an interest rate of 9%, and a payout of about $1,000,000. Alternatively, the individual selects to rollover the payout and receive payments, which may be deferred to start on a set future date.

In an embodiment, should the individual discontinue payments prior to the end of the term, the entity optionally pays the individual nothing or pays the individual a remainder amount. The remainder amount is derived based on factors such as the time remaining in the term of the product, market performance, the amount owed to the loaner, fees due the entity, and the like. The entity may also offer a rider for the product for a market value adjustment to the amount remaining based on the circumstances of the early termination.

### BRIEF DESCRIPTION OF THE DRAWINGS

FIG. 1 is a diagrammatic representation of the system.

FIG. 2 is a table of payment reductions based on employer contributions and various lump sums contributed to a product by a consumer.

FIG. 3 is a listing of the S&P Indices used to calculate market annualized rates of return for specific periods of years.

FIG. 4 is a list of annual gross margins attained on a product with a 30 year term initiated in any of the years listed.

FIG. 5 is a table of returns for an example product purchased in the years listed using a combined low risk/2-beta investment strategy.

FIG. 6 is a table showing an example of the reinsurance embodiment of the invention.

FIG. 7 is a table showing a second example of the reinsurance embodiment of the invention.

### DETAILED DESCRIPTION OF THE INVENTION

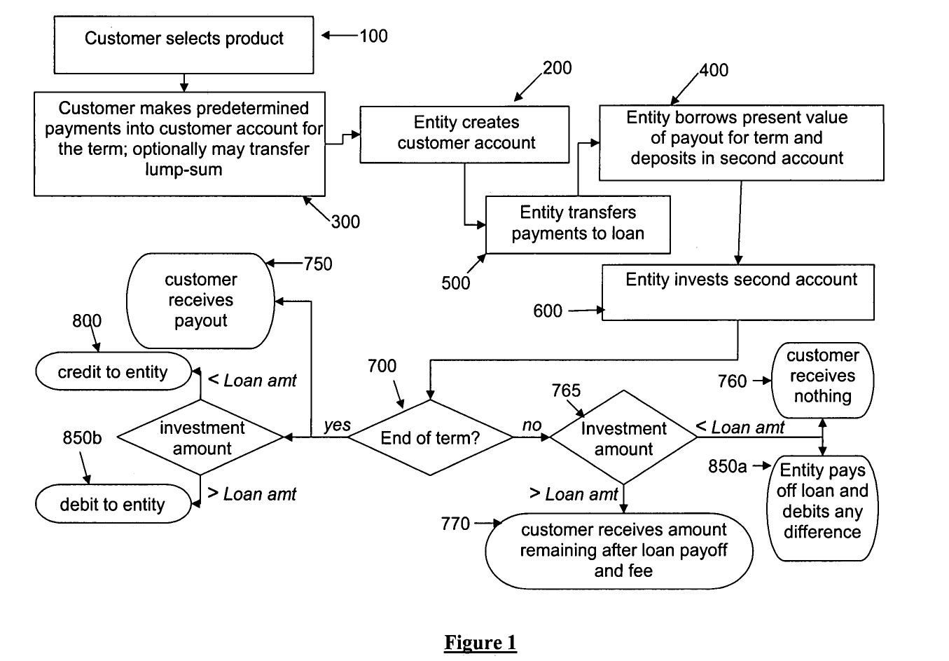

As depicted in FIG. 1, a customer selects a product offered by an entity 100. The product has a given payout goal and term. The customer agrees to make payments as determined by the entity. The entity sets up a customer account that received deposits of the payments 200. The payments may be due in any period, such as bi-weekly, weekly, every other week, bi-monthly, monthly, every other month, quarterly, bi-yearly, yearly, and the like. The payments from the customer are deposited into the customer account 300. Optionally, the customer may transfer a lump-sum amount to the customer account. The payments are predetermined by the entity based on factors such as the payout goal, the term, any lump-sum and or other monies paid in, and the like.

The entity borrows an amount equal to the present value of the payout goal using a discount factor equivalent to the return for the payout goal from a loaner and deposits it into a separate interest bearing account 400. In an embodiment, the return is determined by the market compounded rate for the term. In an embodiment, the return is a rate ranging from about 4% to about 15%. In a preferred embodiment, the rate is about 6% to about 9%. The entity pays the loaner an amount equal to the payments made by the customer from the customer account 500. The customer account is used to secure the separate account, thus the amount borrowed becomes a “risk free” investment for the loaner.

The entity invests the funds in the separate account in one or more investment 600. In an embodiment, the entity invests the funds in the separate account in one or more investment that achieves a 2-beta return based on the S&P Index compounded rate throughout the lifetime of the investment. To achieve a 2-beta return, the entity uses an existing investment strategy, creates a new market investing tool or purchases options that allow the entity to determine such 2-beta investments, such as options, derivatives, 2-beta mutual funds, and the like. By investing money and achieving a rate of return compounding at 2 times the compounded average for the market, the entity may achieves gross margins on spreads guaranteed about 300 bps up to about 9000 basis points per year (average of about 20%). The entity optionally invests in investments that have rates of return at least equal to the rate of return required for the loan.

In an embodiment, the entity uses a combined investment strategy to invest the funds in the separate account, such as investing a portion of the borrowed amount in one or more 2-beta investment and a second portion in one or more lower risk investment. The lower risk investment is a conservative investment, such as, but not limited to, a bond backed investment, real estate, treasury bills, certificates of deposit, money market funds, fixed income securities, savings accounts, and the like. In an embodiment using a combined investment strategy, losses are limited to three percent (−3%) per year. Alternatively, the entity reinsures the investment to guarantee no loss. In an embodiment, the entity reinsures the investment to guarantee a reinsured return. The reinsured return may be any amount. In an embodiment, the reinsured return ranges from about 1% to about 20% per year. In a preferred embodiment, the reinsured return ranges from about 1% to about 12%. The combined investment strategy compensates for downward fluctuations in the market while taking advantage of the historical growth of the market. The following example further illustrates this aspect of the invention:

### EXAMPLE I

Upon purchase of a product by a customer, the entity borrows $100 (one skilled in the art would understand that the borrowed amount could be any amount based on the product, $100 is used in this example for simplicity). The entity invests $92 in a lower risk investment, such as bond backed investments, assuring a 6% rate of return, or $5.52 after one year. With the remaining $8, the entity purchases an investment vehicle that will return a 2-beta, such as but not limited to S&P Index options. In this example, the option has an underlying equity value of $200.

In this example, the market return over the next year is 20%, and the option is worth $40 ($200 underlying value adding 20%). The entity books the $40 and the $5.52 earned on the bond backed investment to the separate account, bringing the total in the separate account to $137.52. Therefore, the rate of return using this investment strategy embodiment when the market shows an increase of 20% is 37.5%.

As an alternative example, when the same amount is invested as described above in a negative market year, such as a market year that returns a −20%, the option value is $0 and the ending balance in the separate account is $97.20.

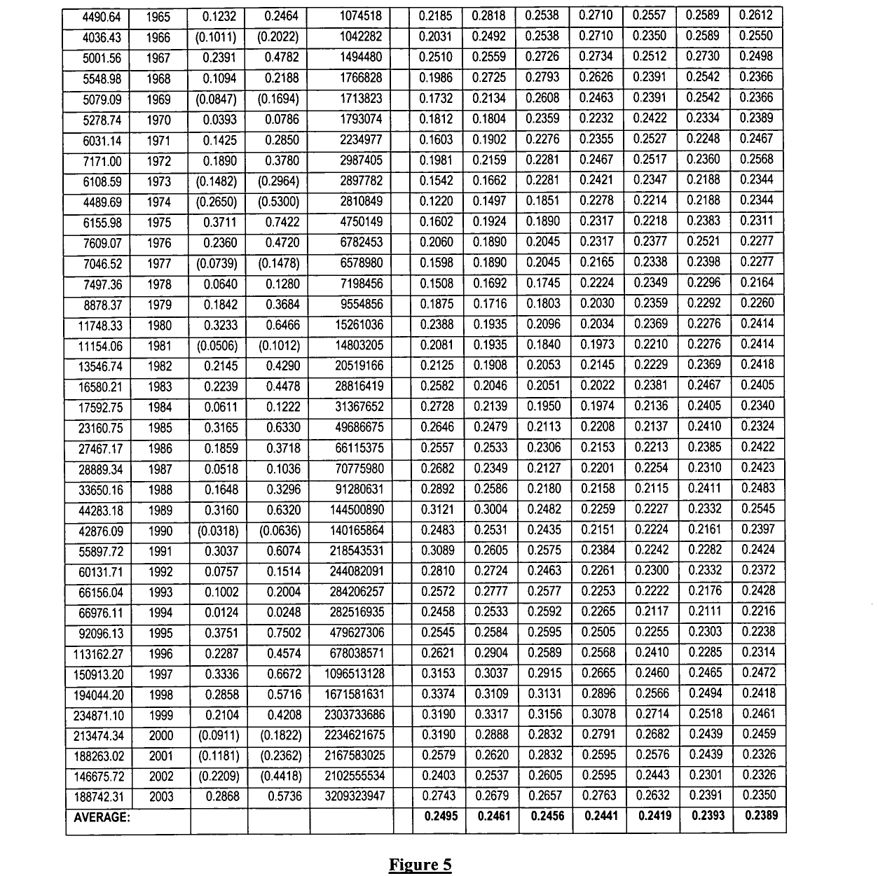

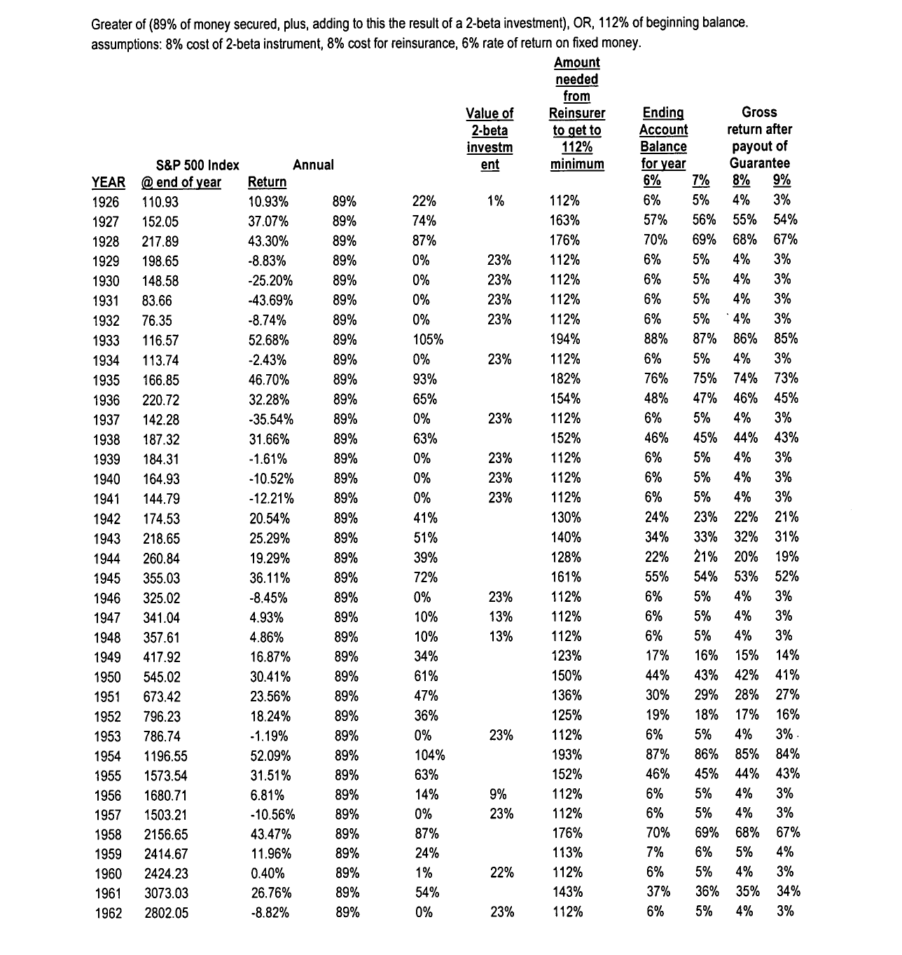

As shown in FIG. 5, historical market data shows that in any 10-15-20-25-30-35-40 year period of the market the average period 2-beta rate of return is about 24%. FIG. 5 lists returns for 10, 25, 20, 25, 30 35 and 40 year products, however, one skilled in the art would realize these are for illustrative purposes and that any term could be substituted. FIG. 5 illustrates an example of returns on a combined 2-beta/less risk investment strategy, wherein about 10% of the investment is invested in one or more 2-beta investment and about 90% of the investment is invested in a lower risk investment. One skilled in the art would realize that any combination of percentages in the investments could be made and that the 10/90 percentage is for illustrative purposes.

In the example illustrated in FIG. 5, the lower risk investment return is about 7.7%. Any low risk return may be substituted. Using the example of FIG. 5, the entity takes advantage of market returns in an up market while limiting losses to about 3% in a down market year (without using reinsurance). To further illustrate this example, a $100 investment made by an entity in 1926 using this combined 2-beta/less risk investment strategy would have resulted in a separate account amount of $3.2 Billion at the end of 2003, if compounded.

Returning to FIG. 1, if the customer remains in the investment until the end of the term 700, the customer receives the payout 750. The customer elects to receive a one time payout or one or more payouts over a period of time. If the customer surrenders the investment before the end of the term, the customer receives 1) return of principal 765, or 2) the amount remaining in the customer account after the loan from the loaner is paid off and after any fee due the entity 770. A surrender includes a voluntary termination by the customer, the customer discontinuing payments, and the death of the customer. Optionally, a Market Value Adjustment (MVA) may be made. The MVA is based on market interest conditions at the time of the surrender compared to the interest rate for the borrowed amount, the changes in the S&P Index for the intervening years from inception of the product, and the number of years remaining in the term. No MVA will be made in the case of a customer's death.

A rider may optionally be included in a product. When the customer discontinues payments, the rider provides for certain circumstances, such as but not limited to a return of investment, an allowed suspension of payments made by the customer for a period of time should the customer become disabled and unable to work, an allowed suspension of payments for a period of time should the customer become unemployed, and the like. In an embodiment, the rider allows for suspension of payments for 2 years for a customer's inability to work, and an allowed suspension of payments for 6 months should the customer become unemployed.

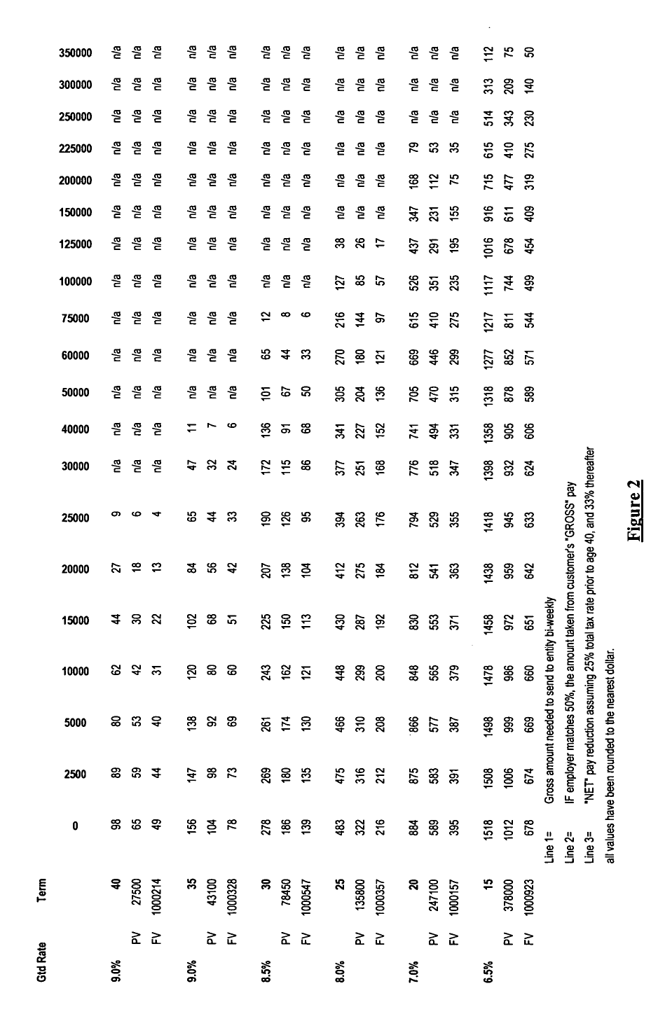

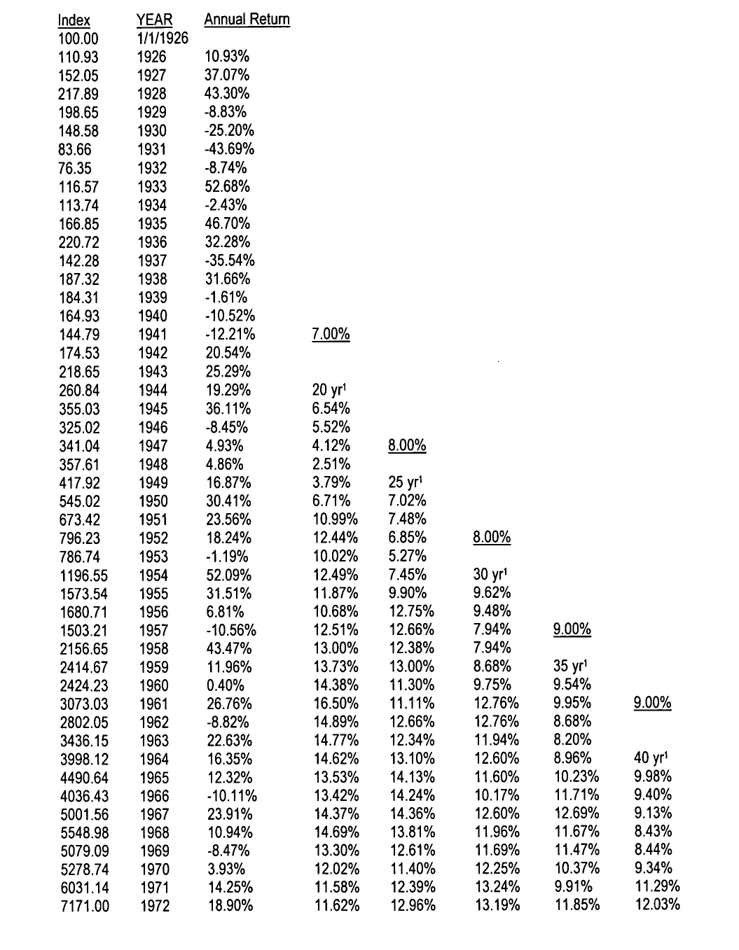

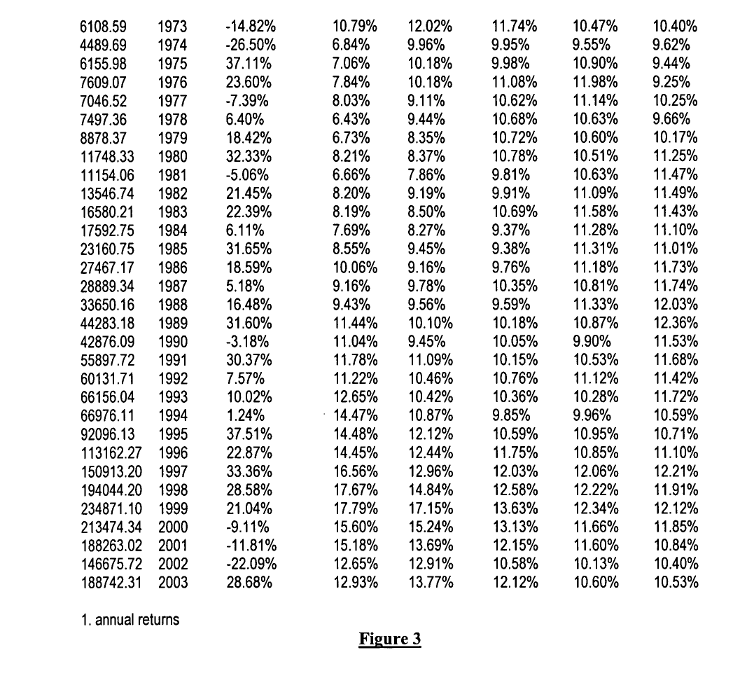

FIG. 2 is a table of payment reductions for various amounts contributed by the customer and or a second party, such as the customer's employer, based on loan interest rates, term, and payout. In the example illustrated in FIG. 2, the guaranteed payout is about $1,000,000; however, one skilled in the art would understand that any payout goal could be used. The entity determines the payment amount based on the loan rate, the term and the payout goal. FIG. 2 lists bi-weekly payments as an example. One skilled in the art would understand that payments could be made on any periodic basis. The table lists (each line 2) the payment reduction for an employer contributing 50% to the payment as an example. One skilled in the art would understand that an employer could make any percent of the payment as a contribution to the payment. FIG. 2 lists net pay reductions based on the predicted age of a customer purchasing a product for a given term. In FIG. 2, 15, 20, 25, 30, 35, and 40 year term products are illustrated as examples, however, any term could be substituted.

FIG. 2 lists payment reductions based on lump-sum contributions by the customer. In the table, the amounts range from $2,500 to $350,000, however, one skilled in the art would understand that any amount relative to the payout could be contributed. As shown in FIG. 2, a customer may not reduce his payment for a given payout goal for a product of a certain term beyond a certain number. For products with higher payouts than about $ 1,000,000, the customer may contribute a higher lump sum. A lump sum may or may not be a rollover from an existing account, such as a retirement account.

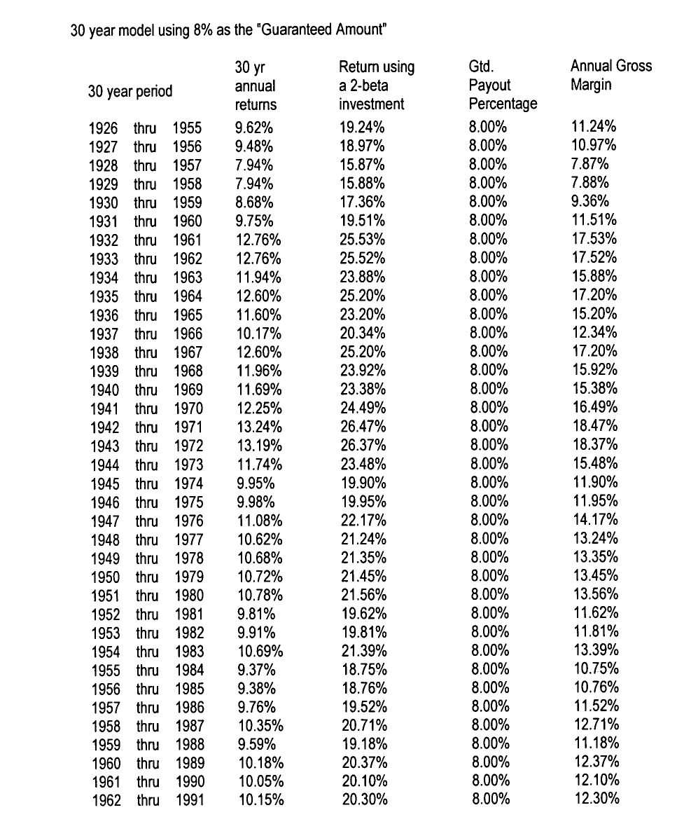

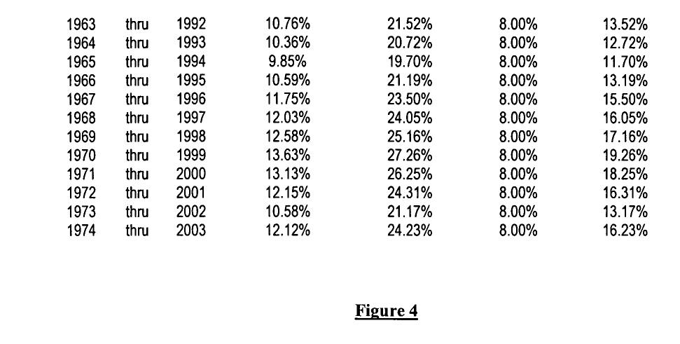

FIG. 3 lists annualized rate of returns for given periods of the US stock market. The first column lists the S&P Index for each year of the market from 1926-2003. The third column is a listing of the rate of return of the market for each year from 1926-2003. The fourth column is a calculation of the annualized rate of return based on 20 year periods. For example, as shown in FIG. 3, the calculated annualized rate of return for the 20 years ending in 1945 is 6.54%; the annualized rate of return for the twenty year period from 1983-2003 is 12.93%. The values in the fifth column of FIG. 3 are the calculated annualized rate of return based on 25 year periods; column six are the calculated annualized rate of return based on 30 year periods; column seven values are the calculated annualized rate of return based on 35 year periods; and column eight values are the calculated annualized rate of return based on 40 year periods of the market. The averages of the annualized rates of return shown in FIG. 3 are 11.13% for 20 years; 11.07% for 25 years; 10.91% for 30 years; 10.80% for 35 years; and 10.80% for 40 years. One skilled in the art would understand that different time spans could be chosen (i.e., 21 years, 22 years, 23 years, etc.) for product terms, and, as time progresses, that shorter or longer periods(i.e., less than 20 and over 40 years) could be used to determine annualized rates of return.

Any period of time may be used to establish the term, provided the term is at least a sufficient number of years to mitigate downswings in the market based on historical data. In an embodiment, the term of a product is one of about 10, 15, 20, 25, 30, 35 and 40 years. The term determines the interest rate for the loan. In an embodiment, a product with a term of 15 years has an interest rate on the loan of about 6.5%; a product with a term of 20 years has an interest rate on the loan of about 7%; a product with a term of 25 years has an has an interest rate on the loan of about 8%; a product with a term of 30 years has an has an interest rate on the loan of about 8%; a product with a term of 35 years has an has an interest rate on the loan of about 9%; and a product with a term of 40 years has an has an interest rate on the loan of about 9%. One skilled in the art would understand that any interest rate could be associated with a product and that longer or shorter terms could have the same or different interest rates. In an embodiment, interest rates are determined based upon the rate that an investment company may be able to achieve in long tern investments and to provide a calculated margin over the annualized return rates, such as those illustrated in FIG. 3.

The following examples illustrate embodiments of the invention:

### EXAMPLE II

An individual selects a product offered by an insurance company that guarantees the individual about a $1,000,000 cash payout at a date 40 years in the future based on a periodic payment made over the same period. The periodic payment is predetermined by the insurance company. The individual delivers a payment of approximately $212 per month to the insurance company each month for 40 years.

The product is administered by a product group within the insurance company. The product group borrows $27,500 from an investment/lending division of the company at an interest rate of 9% for 40 years. To repay the loan, the product group pays the investment/lending division $212 per month for 40 years.

The product group achieves the 2-beta return by investing the loaned money in instruments, such as options, derivatives, 2-beta mutual funds, etc., to achieve a rate of return equal to approximately 2 times the compounded annual rate of return of a given index. For this example, the index is the S&P Index. In this example, the 2-beta investment rate is 20% per year.

At the end of the 40 years, the entity pays the individual the guaranteed payout of about $1,000,000.

When a customer decides to terminate a product prior to the end of the term, the entity has the option of returning nothing to the customer, or returning an amount remaining after the loan from the loaner is paid off and or after collecting any fee. The following example illustrates the system's options for early termination:

### EXAMPLE III

After purchasing a 40 year product (without adding any additional lump-sum) in 1999, a customer decides after 5 years to terminate the product. Upon notification, the entity calculates a maximum payout. The maximum payout equals the amount of the customer's payments times the interest on the loan. In this example, the customer has made 5 years of monthly payments of $212. The interest rate of the loan is 9%. The maximum payout in this example is about $16,600.

The entity then determines the maximum level of payout to the amount in the separate account. In an embodiment, the options available to the entity range from returning the principal to paying an amount equal to the guaranteed amount. The amount in the separate account is determined by the amount of the initial loan, what actually happens in the market over the period between initiation of the product and early termination, and the investment strategy of the entity. In this example, the loan amount is $27,500. As shown in FIG. 3, the market returns were 21.04% in 1999, −9.11 % in 2000, −11.81 % in 2001, −22.09% in 2002, and 28.68% in 2003. The entity in this example invested 10% of the loan amount for options/investments returning 2-beta, and 90% in bond-back instruments returning 6%; therefore the loan account value grows to 53,882, which is calculated in the following table:

| Year | Market return | 2 Beta | Amount in separate account |
|---|---|---|---|
| 1999 | 21.04% | Y | $38,247 |
| 2000 | −9.11% | N | $37,099 |
| 2001 | −11.81% | N | $35,986 |
| 2002 | −22.09% | N | $34,907 |
| 2003 | 28.68% | Y | $53,882 |

The investment/lending division has an outstanding loan of $27,100 (after payments, including interest less principal repayment). The entity transfers $27,100 from the separate account to the loaner. The money remaining in the separate account is $26,782 ($53,882-$27,100). In this example, a gross gain of $26,782 has been incurred by the entity (minus any administrative expenses over the period). In this example, the customer receives at least the return of principal, because the investment was in a positive position when closed out. Alternatively, the entity may transfer another specified amount to the customer based on any existing rider.

Returning to FIG. 1, when a customer terminates a product prior to the term of the product, the entity credits the amount remaining 800 after any payment to the customer to its bottom line to offset any losses 850a, 850b due to terminations resulting in $0 remainders or deficits where the returns in the market were negative for a significant number of years during the term of the product.

The loan is guaranteed by the entity. Historical rates as listed in FIG. 3 show the historic known risk/return of the present invention. Existing and or new investment vehicles and investment strategies are used to achieve the returns used herein.

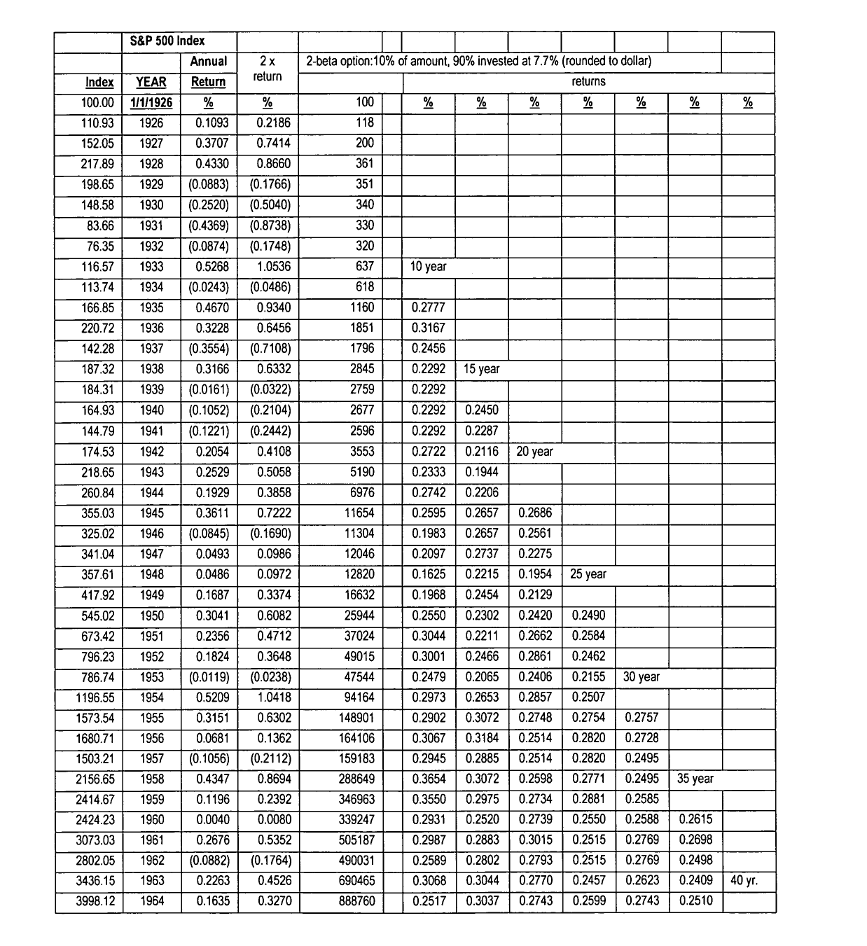

FIG. 4 illustrates an example of the invention for a 30 year product with an 8% interest rate. The third column of FIG. 4 lists 2-beta returns based on historic returns of the market. In this example, such a product initiated in any of the years listed yields the annual gross margin for that period listed in the right-hand column. As shown in FIG. 4, only products purchase in 1928 and 1929 would have yielded an annual gross margin of less that the example's interest rate for the loan (7.87% and 7.88% vs. 8%), while the average of all annual gross margins for 30 year products purchased in the years 1926 to 1972 is 13.82%, for an average of 1382 basis points above the loan rate.

In an embodiment, an entity reinsures a product. A entity optionally uses reinsurance to insulate a product from incurring losses in any market down year. In this embodiment, an entity assesses the market to determine “risk” years. As an example, over the last 80 years, the market has averaged one down year to every three up years, for an approximate average of 1 down year in each 4 year period.

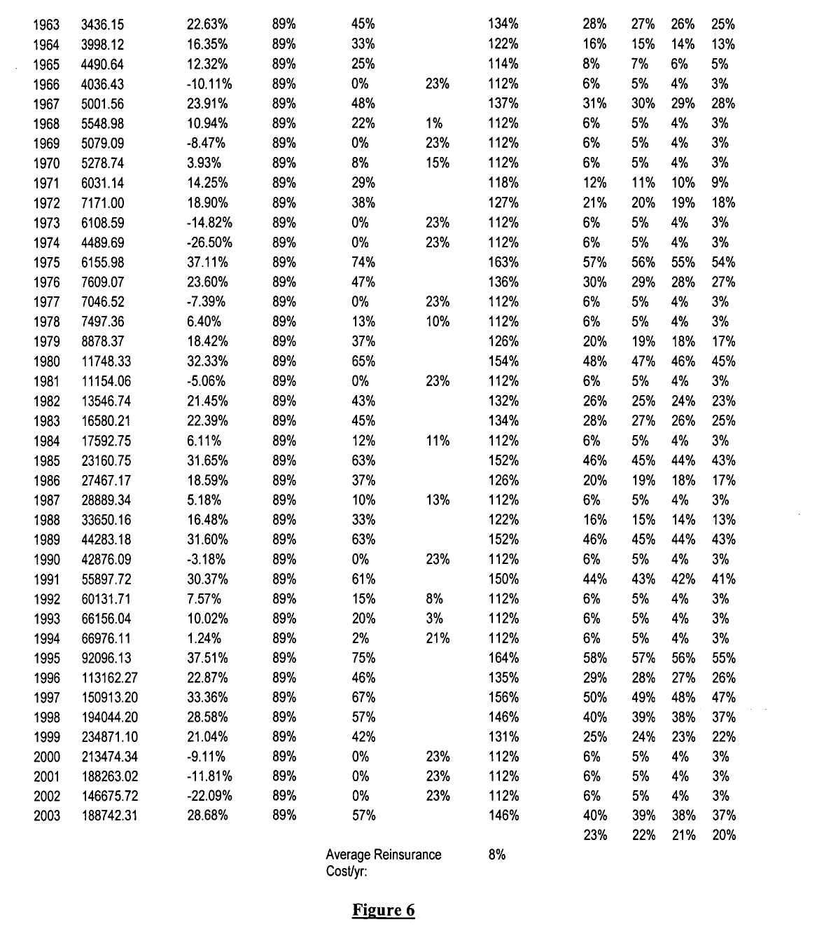

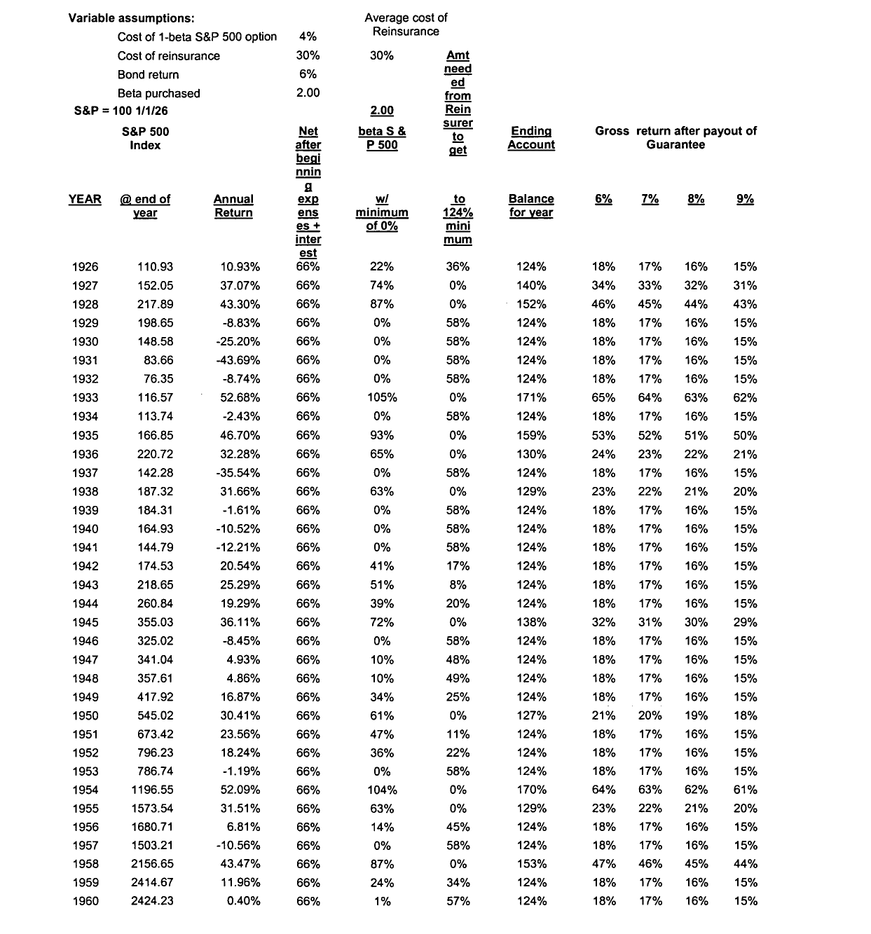

FIG. 6 illustrates an example of using a combined investment strategy of a 2-beta investment consisting of 8% of the amount in the separate account and investing the remainder in a 6% bond. As shown in FIG. 6, the net amount in the separate account is a percentage of the original amount based on the purchase of the 2-beta instrument and the reinsurance policy and the accrual of interest on the bond. In this example, the net amount is 89% (100−8−8+(84*.06)). One skilled in the art would readily realize that the net amount would vary based on factors including but not limited to the percentage of the amount in the separate account used to purchase the 2-beta instrument, the cost of the reinsurance, and the interest rate of the lower risk investment. The cost of the reinsurance in this example is based on a requirement by the entity of a minimum 12% yearly return in the market. Based on historic annual returns, column 5 of FIG. 6 lists (1) the percent return of a successful 2-beta investment made in that year or, (2) the minimum percentage required in each year of the market to achieve a 12% return up to 23% (112−89=23). Column 6 of FIG. 6 lists the percentage of the investment required from the reinsurer to achieve the consistent 12% return for each year of the market. For this example, the average reinsurance cost based on market historic data is 8% per year.

To further illustrate the reinsurance aspect of the invention, a consumer purchases a product for $100. The entity invests $8 in an option returning 2-beta, invests the remainder in a 6% instrument, and purchases reinsurance for $8. Should the market return 15% after 1 year, the option is worth $30, and the entity has about $119 in the account, for a gross margin of 19%. Should the market return −20%, the option is worth $0, the reinsurer pays the entity about $23, and the entity has about $112 in the account for a gross margin of 12%.

In an embodiment, an entity provides self-reinsurance and the fee charged to the division of the entity investing the loan is the cost of the reinsurance. Optionally, an entity purchases reinsurance from a third party, which may include a different premium.

As shown in columns 8-11 of FIG. 6, gross returns after a guaranteed payout in this example showing positive returns for each year of the market since 1926. As shown in FIG. 6, the average rate of return over the years is consistent with the expected return for the combined 2-beta/lower risk investment strategy. Using this embodiment, an entity stabilizes the return over each year of the term of a product, insulating the entity from incurring any loss, thereby eliminating down year risk. The reinsurance embodiment of the present invention is optionally employed by an entity planning for early customer termination of products. Using a reinsurance option, the separate account would not have a negative amount. Upon early termination in a reinsurance embodiment, the customer recovers amounts paid up to the termination remaining after the entity pays off the loan and subtracts any fees.

As an alternative, the customer may elect to roll over the payout and receive more than one payment over a period of time. In an embodiment, upon expiration of the term of a product, the entity retains the guaranteed payout amount in the account and pays a predetermined amount to the customer at intervals over a set period of time. The entity optionally invests the payout amount in a guaranteed principal investment, a 2-beta/lower risk investment, a 2-beta investment, and the like, and pays the customer a predetermined amount over a set period of time. Where the entity uses other than a guaranteed principal, the entity may elect to use reinsurance.

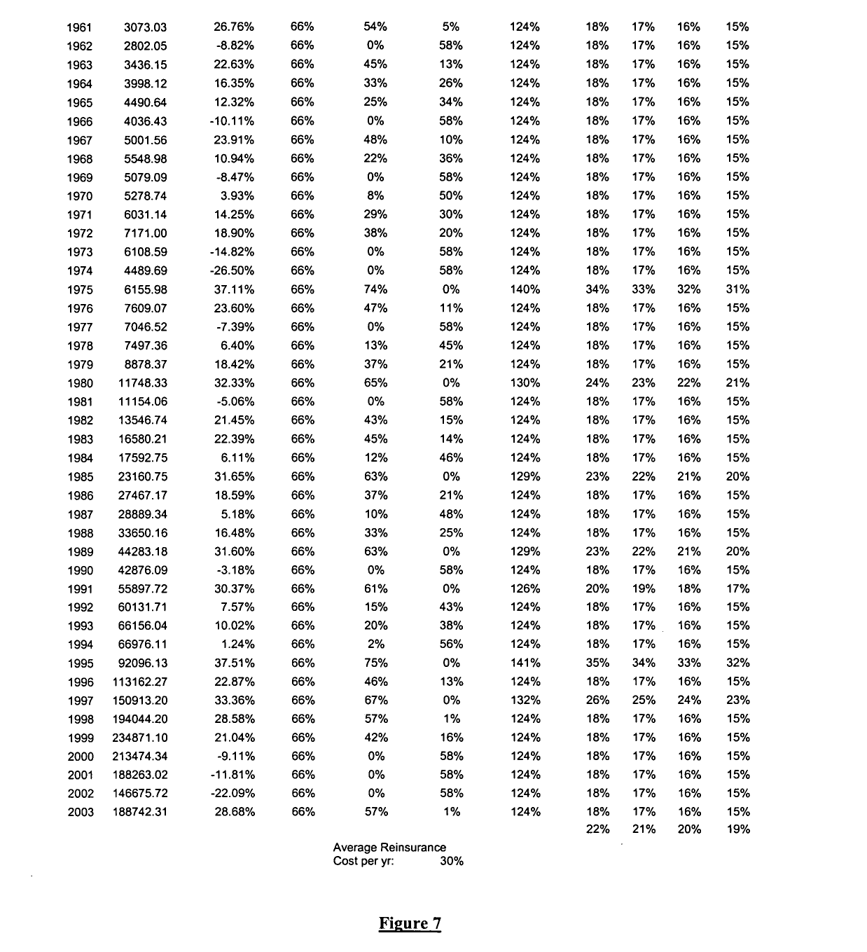

FIG. 7 illustrates an example of reinsurance used to insure a combined investment strategy for a rollover. In this example, the rollover is invested in a 2-beta investment consisting of 4% of the amount of the rollover and investing the remainder in a lower risk investment with a return of 6%. As shown in FIG. 7, the net amount in the separate account remains constant at 66%. One skilled in the art would readily realize that the net amount would vary based on factors including but not limited to the percentage of the amount in the separate account used to purchase the 2-beta instrument, the cost of the reinsurance, the interest rate of the lower risk investment, and the like. Based on historic annual returns, FIG. 7 lists the percent return of a successful 2-beta investment made in that year and the amount required from the reinsurer to maintain a minimum return of 124%. As shown in this example, the average cost of reinsurance is about 30%.

The present invention offers advantages to consumers as well as entities offering the products. The concept of pre-funding the present value of the amount needed to achieve a certain amount in the future has not been exhibited by any insurance company in the past as a way to eliminate the uncertainty of the “compounding dilemma.” Instruments to achieve leveraged rates or returns have only been available for a few years, and have only recently proven viable investment strategies. Insurance companies, which traditionally invest in conservative investments, will be able to engage in the method of the present invention relatively risk free, in that the loan is secured by the consumer payments.

One skilled in the art will understand that the description of the present invention herein is presented for purposes of illustration and that the design of the present invention should not be restricted to only one configuration or purpose, but rather may be of any configuration or purpose which essentially accomplishes the same effect.

The foregoing descriptions of specific embodiments and examples of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated. It is therefore to be understood that within the scope of the appended claims, the invention may be practiced otherwise than as specifically described herein.

What is claimed is:

1. An investment vehicle comprising a term, a guaranteed payout goal, one or more periodic payment to an entity offering the investment over the term, a loan from a loaner to the entity, a tool, and optionally a rider, said loan bearing interest equal to present value of the payout goal, said entity transferring the paid payments to the loaner during the term and investing the loan in the tool over the term and paying a holder of the investment vehicle the payout upon 1) an end of the term, or 2) in more than one disbursement over a period of time after the end of the term.

2. The investment vehicle of claim 1 wherein the payments are one of bi-weekly, weekly, every other week, bimonthly, monthly, every other month, quarterly, bi-yearly, and yearly.

3. The investment vehicle of claim 1 wherein the holder adds a lump-sum amount to the payments.

4. The investment vehicle of claim 1 wherein the payments are made by the holder and one or more second party.

5. The investment vehicle of claim 4 wherein the second party is an employer of the holder.

6. The investment vehicle of claim 1 wherein the payments are determined by the entity based on the payout goal, the term and any optional lump-sum contributed by the holder.

7. The investment vehicle of claim 1 wherein the interest rate applied to the loan is from about 6% to about 9%.

8. The investment vehicle of claim 1 wherein the tool is selected from the group of 1) at least one 2-beta investment based on a S&P Index compounded rate throughout the term, 2) a combination of one or more 2-beta investment and one or more lower risk investment, and 3) a guaranteed investment; said entity optionally reinsuring the tool.

9. The investment vehicle of claim 8 wherein the one or more lower risk investment is a bond backed investment.

10. The investment vehicle of claim 8 wherein the entity invests approximately 5% to approximately 10% of the loan in one or more 2-beta investment and approximately 90% to approximately 95% of the loan in one or more lower risk investment.

11. The investment vehicle of claim 1 wherein the holder discontinues payments prior to the end of the term, said holder receiving, rather than the payout, one of nothing, an amount remaining after the loaner is paid off and after any fee due the entity, and a rider amount.

12. The investment vehicle of claim 11 wherein a market value adjustment is made to the amount remaining.

13. The investment vehicle of claim 1 wherein the term equals a sufficient number of years to mitigate negative returns in a trading market.

14. The investment vehicle of claim 1 wherein the term ranges from about 10 to about 40 years.

15. The investment vehicle of claim 1 wherein the term is about 40 years, the interest rate is about 9%, and the payout is about $1,000,000.

16. The investment vehicle of claim 1 wherein the entity reinsures the tool.

17. A method of providing an investment vehicle for a holder by an entity comprising the steps of:
predetermining a term of the investment;
predetermining a payout goal;
predetermining one or more payment to be made by the holder;
predetermining an amount to be borrowed from a loaner by the entity, said borrowed amount equal to the present value of the payout goal wherein a discount factor used to determine the borrowed amount is equal to the interest rate applied to the borrowed amount;
optionally providing a rider;
paying the one or more payment to the entity by the holder during the term, said payments optionally including a lump sum and or one or more third party contribution;
transferring the paid payments from the entity to the loaner during the term;
investing the amount borrowed in a tool over the term; and,
paying the holder 1) the payout upon an end of the term or 2) more than one disbursement after the end of the term.

18. The method of claim 17 wherein the payments are one of bi-weekly, weekly, every other week, bimonthly, monthly, every other month, quarterly, bi-yearly, and yearly.

19. The method of claim 17 wherein the payments are determined by the entity based on the payout goal, the term and any lump sum.

20. The method of claim 17 wherein the interest rate applied to the amount borrowed is from about 6% to about 9%.

21. The method of claim 17 wherein the tool is selected from the group 1) at least one 2-beta investment based on a S&P Index compounded rate throughout the term, 2) a combination of one or more 2-beta investment and one or more lower risk investment, and 3) a guaranteed investment; said entity optionally reinsuring the tool.

22. The method of claim 21 wherein the one or more lower risk investment is a bond backed investment.

23. The method of claim 21 wherein the entity invests approximately 10% of the borrowed amount in one or more 2-beta investment and approximately 90% in one or more lower risk investment.

24. The method of claim 17 wherein prior to the end of the term, the holder discontinues payment and receives, rather than the payout, one of nothing, an amount remaining after the loaner is paid off and after any fee due the entity, and a rider amount.

25. The method of claim 24 further comprising making a market value adjustment.

26. The method of claim 17 wherein the term equals a sufficient number of years to mitigate negative returns in a trading market.

27. The method of claim 17 wherein the term ranges from about 10 to about 40 years.

28. The method of claim 17 wherein the term is about 40 years, the interest rate is about 9%, and the payout is about $1,000,000.

29. The method of claim 17 further comprising the entity reinsuring the tool.

30. An investment vehicle comprising a term, a guaranteed payout goal, one or more periodic payment to an entity offering the investment over the term, a loan from a loaner to the entity, a tool, and optionally a rider; said term ranging from about 10 to about 40 years; said payments made one of bi-weekly, weekly, every other week, bimonthly, monthly, every other month, quarterly, bi-yearly, and yearly by 1) a holder and or 2) one or more second party; said holder optionally adding a lump-sum amount to the payments; said payments determined by the entity based on the payout goal, the term and any optional lump-sum contributed by the holder; said loan bearing interest rates equal to about 6% to about 9%; said tool one of 1) at least one 2-beta investment based on a S&P Index compounded rate throughout the term, 2) a combination of one or more 2-beta investment and one or more lower risk investment, and 3) a guaranteed investment; said entity optionally reinsuring the tool; said entity transferring the paid payments to the loaner during the term and investing the loan in the tool over the term and paying a holder of the investment vehicle the payout upon 1) an end of the term, or 2) in more than one disbursement over a period of time after the end of the term.
